(19) United States
(12) Patent Application Publication
(10) Pub. No.: US 2009/0075594 A1
(43) Pub. Date: Mar. 19, 2009

(54) COMMUNICATION APPARATUS, COMMUNICATION METHOD, AND COMPUTER PROGRAM FOR CONTROLLING COMMUNICATION APPARATUS

(75) Inventors: Takahiro Shichino, Kawasaki-shi (JP); Takatoshi Hirose, Yokohama-shi (JP); Tetsuya Yamamoto, Kawasaki-shi (JP); Hidetada Nago, Kawasaki-shi (JP); Hajime Shimura, Koshigaya-shi (JP); Hiroshi Mashimo, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/912,438

(22) PCT Filed: May 26, 2006
(86) PCT No.: PCT/JP2006/311032

§ 371 Date: Oct. 24, 2007

(30) Foreign Application Priority Data
Jun. 17, 2005 (JP) 2005-177961

(51) Int. Cl. H04B 7/00

(52) U.S. Cl. 455/41.3

(57) ABSTRACT

In a system in which a communication adapter installing UPnP is connected to a printer to provide a print service, the communication adapter notifies a device that the printer joins the network or leaves from it, based on determination whether the printer can provide a service. Hence, the present invention can suppress from issuing a service request to a printer which cannot provide the service.

### TECHNICAL FIELD

The present invention relates to a communication apparatus to be connected to a first electronic apparatus, a communication method, and a computer program for controlling the communication apparatus.

### BACKGROUND ART

UPnP (Universal Plug and Play) is standardized as a technical specification for connecting devices such as a PC and peripheral equipment in home via a network to provide their functions to each other.

In recent years, wireless communication is performed via a wireless LAN or the like to connect a printer, digital still camera (to be referred to as a DSC hereinafter), PC, and the like. For example, a service is proposed in which, upon connecting a communication adapter to a printer, a DSC with a wireless communication function can instruct, by wireless communication, the printer to print. UPnP can also be applied to such service.

UPnP defines that a device transmits an “Alive” message when it joins a logical network, and a device transmits a “Bye-Bye” message when it leaves from the logical network.

However, UPnP does not define a determination criterion for determining if a device joins the logical network or not, and if it leaves from it or not.

When the DSC with the wireless communication function instructs the printer connected to the communication adapter to print, the printer cannot always accept a print instruction even if the DSC is wirelessly connected to the communication adapter. Accordingly, the DSC must transmit the print instruction to the printer when the printer can accept it.

For example, as determination criteria for determining whether a printer can accept a print instruction, the following pieces of information are available:

1. information representing a failure or a recovery from the failure of a printer; and

2. information representing physical connection/disconnection between a printer and a communication adapter.

Japanese Patent Laid-Open No. 11-194901 proposes a technique for wirelessly notifying a device of information representing a failure when a printer has failed, and a technique for notifying the device of information representing a recovery from the failure when the printer has recovered from the failure. With these techniques, the device to be communicated with the printer can know a failure or a recovery from the failure of the printer.

However, the above-described prior art does not describe physical connection/disconnection between the printer and the communication adapter.

Even if the communication adapter is connected to a partner device (e.g. the DSC) via a network, the printer cannot provide a print service when the communication adapter is not connected to the printer. Even if the communication adapter is connected to the printer, the printer cannot provide a print service when the status of the printer is not suited to provide the print service.

Accordingly, even if the communication adapter notifies, based on the connection status with the network, a device that the printer joins the network, the device which has received the notification cannot always use a print service in practice.

Such problem occurs not only when the communication adapter is to be connected to the printer, but also when various devices such as a scanner and monitoring camera capable of remote control are to be used.

### DISCLOSURE OF INVENTION

It is a feature of the present invention to solve the above-described problem.

For example, the feature of the present invention is to prevent issuing a service request to an electronic apparatus incapable of providing a service, when the communication apparatus is connected to the electronic apparatus for providing a predetermined service. Another feature of the present invention will be apparent from the following specification and accompanying drawings.

According to an aspect of the present invention, there is provided with a communication apparatus comprising:

a first interface, adapted to communicate with a first electronic apparatus;

a second interface, adapted to communicate with a second electronic apparatus via a network;

a determination unit, adapted to determine whether or not the first electronic apparatus can provide a service; and

a notification unit, adapted to notify, in accordance with the determination by the determination unit, the second electronic apparatus that the first electronic apparatus joins the network or leaves from the network.

According to another aspect of the present invention, there is provided with a communication apparatus comprising:

a first interface, adapted to communicate with a first electronic apparatus;

a second interface, adapted to communicate with a second electronic apparatus;

a determination unit, adapted to determine whether or not the first electronic apparatus can provide a service; and

a notification unit, adapted to notify, in accordance with the determination by the determination unit, that the first electronic apparatus starts or stops providing the service.

According to another aspect of the present invention, there is provided with a communication method of a communication apparatus, comprising:

a connection step of connecting the communication apparatus to a second electronic apparatus via a network;

a determination step of determining whether or not a first electronic apparatus connected to the communication apparatus via an interface can provide a service; and

a notification step of notifying, in accordance with the determination in the determination step, that the first electronic apparatus joins the network or leaves from the network.

This summary of the invention does not necessarily describe all necessary features so that the invention may also be a sub-combination of these described features.

Other features, objects and advantages of the present invention will be apparent from the following description when taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a system diagram according to the first embodiment;

FIG. 2 is a schematic view of a communication adapter according to the first embodiment;

FIG. 3 is a flowchart showing processing executed by the communication adapter according to the first embodiment;

FIG. 4 is a communication sequence chart according to the first embodiment;

FIG. 5 shows a view illustrating an example of content of a printer connection management register;

FIG. 6 shows a view illustrating an example of content of a service status management register;

FIG. 7 is a schematic view of a communication adapter according to the second embodiment;

FIG. 8 is a flowchart showing processing pertaining to control of a wireless unit according to the second embodiment;

FIG. 9 is a flowchart showing processing pertaining to control of a USB device controller according to the second embodiment; and

FIG. 10 shows a view illustrating an example of content of a wireless LAN connection management register.

### BEST MODE FOR CARRYING OUT THE INVENTION

Detailed embodiments of the present invention will be described in detail with reference to the accompanying drawings.

Note that the technical scope of the present invention is not limited to the following specific embodiments thereof except as defined in the appended claims. In addition, all combinations of characteristic features described in the embodiments are not always essential to the solving means of the invention.

### First Embodiment

In the first embodiment, a system in which a communication adapter is connected to a printer for providing a print service to a DSC with a wireless communication function will be described.

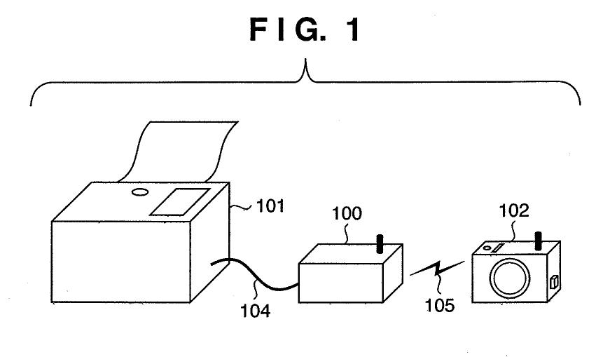

FIG. 1 is a system diagram according to the first embodiment. A communication adapter 100 is connected to a printer 101 via a USB cable 104. The communication adapter 100 is also connected to a DSC 102 via a wireless LAN 105. Although not shown, the communication adapter 100 installs UPnP as a function for searching for a device and a service. A print service from the printer 101 is relayed via the communication adapter 100 to the DSC 102.

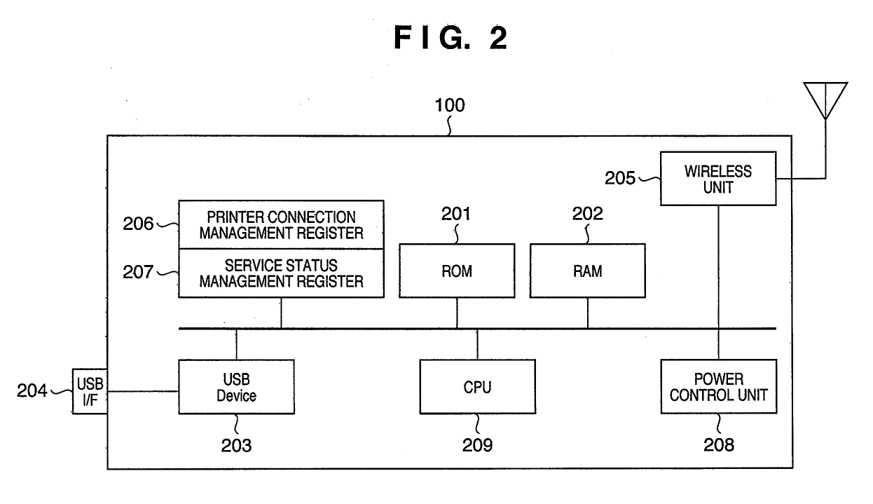

FIG. 2 is a schematic view of the communication adapter 100 according to the first embodiment. A ROM (Read Only Memory) 201 stores an operation program and the like for operating the communication adapter 100 (to be described later). A RAM (Random Access Memory) 202 serves as a work memory and an area for expanding the operation program. A USB (Universal Serial Bus) device controller 203 transmits/receives data to/from the printer 101 via a USB interface 204. A wireless unit 205 transmits/receives a wireless LAN signal.

A printer connection management register 206 stores information pertaining to whether the communication adapter 100 can communicate with the printer 101 via the USB interface 204. A service status management register 207 stores information pertaining to whether the communication adapter 100 can provide a print service from the printer 101 to the DSC 102 via the wireless unit 205. A power control unit 208 controls electric power to be supplied to each unit in the communication adapter 100. A CPU 209 controls the overall communication adapter 100.

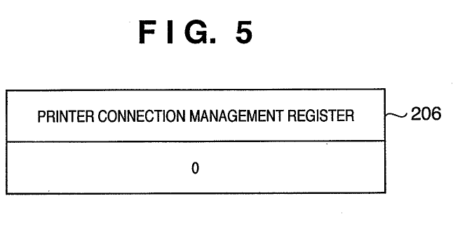

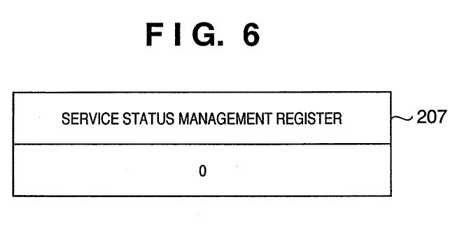

The above-described two registers will be described next. FIG. 5 is a view showing an example of content of the printer connection management register 206. When USB communication is possible, the CPU 209 writes “1” in the printer connection management register 206. Otherwise, the CPU 209 writes “0” in the printer connection management register 206. FIG. 6 is a view showing an example of the content of the service status management register 207. When the communication adapter 100 can provide a print service from the printer 101 to the DSC 102 via the wireless unit 205, the CPU 209 writes “1” in the service status management register 207. Otherwise, the CPU 209 writes “0” in service status management register 207.

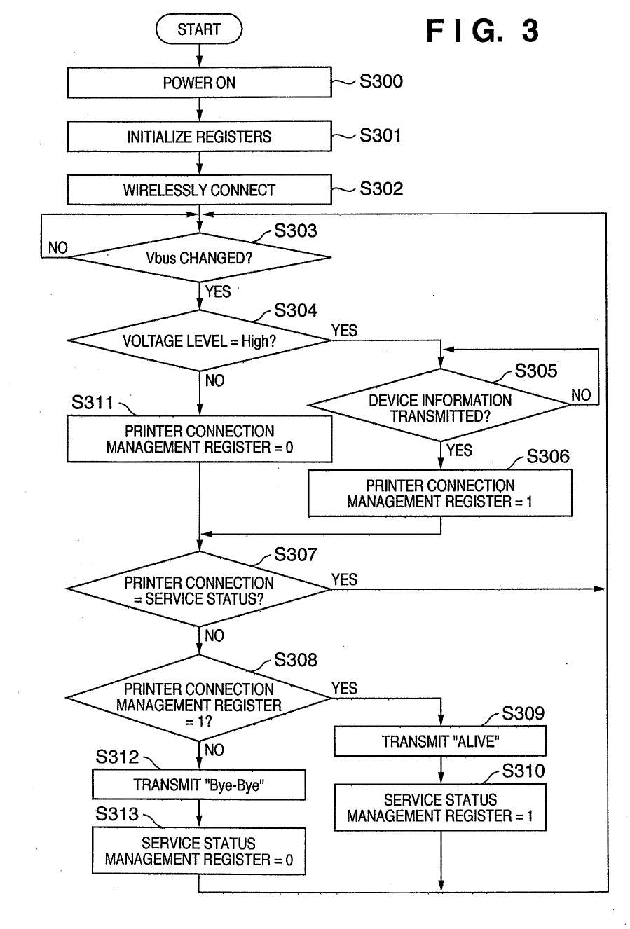

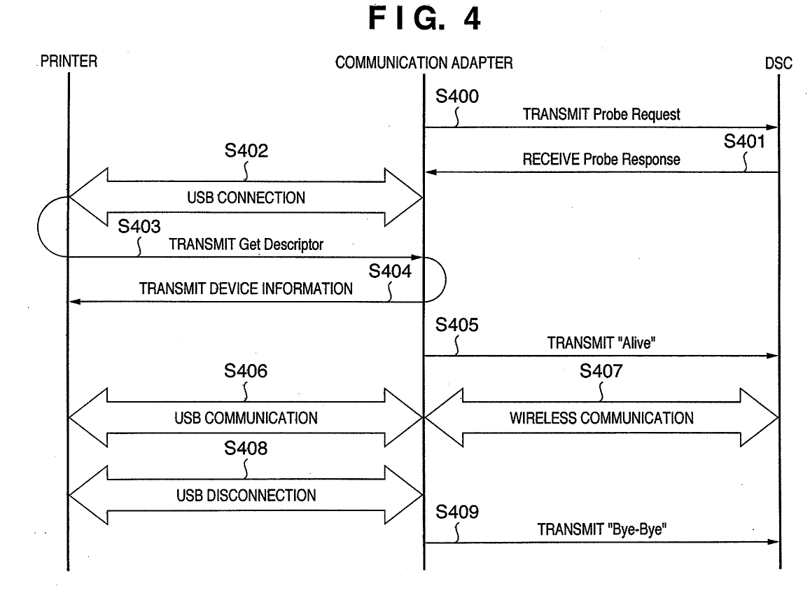

FIG. 3 is a flowchart showing processing executed by the communication adapter 100. FIG. 4 is a sequence chart showing the flow of processing of controlling communication among the printer 101, communication adapter 100, and DSC 102.

When the communication adapter 100 is powered on (step S300), the power control unit 208 supplies the electric power to the wireless unit 205. Upon power-on, the CPU 209 initializes the printer connection management register 206 and the service status management register 207 (step S301). Since the USB device controller 203 cannot be completely initialized immediately after the power-on, the communication adapter 100 cannot communicate with the printer 101 via the USB interface 204. In this state, the communication adapter 100 cannot provide a print service from the printer 101 to the DSC 102 via the wireless unit 205. Hence, the CPU 209 writes “0” as an initial value in both the printer connection management register 206 and the service status management register 207.

Upon completely initializing the registers, the communication adapter 100 is wirelessly connected to the DSC 102 via the wireless unit 205 (step S302). More specifically, the communication adapter 100 transmits a Probe Request signal to the DSC 102 (step S400). In response to this Probe Request signal, the communication adapter 100 receives a Probe Response signal from the DSC 102 (step S401).

The communication adapter 100 is then connected to the printer 101 via the USB cable 104. The CPU 209 monitors a Vbus signal (not shown) serving as a signal line of the USB interface 204, and checks whether the Vbus signal changes (step S303). When the voltage level of the Vbus signal goes high, the CPU 209 determines that the USB is connected. When the voltage level of the Vbus signal goes low, the CPU 209 determines that the USB is disconnected (step S304). In this case, since the voltage level goes high, the CPU 209 determines that the USB is connected (YES in step S304, step S402). Upon receiving, from the printer 101, a Get Descriptor signal for prompting to transmit device information (step S403), the communication adapter 100 transmits the device information to the printer 101 (YES in step S305, step S404). The CPU 209 then determines that the printer 101 and the USB interface 204 are completely initialized, thereby establishing USB communication. Accordingly, the CPU 209 writes “1” in the printer connection management register 206 (step S306).

Next, the CPU 209 compares the content of the printer connection management register 206 with that of the service status management register 207 (step S307). The CPU 209 has written “1” in the printer connection management register 206 in step S306, and written “0” in the service status management register 207 when initializing the registers in step S301. That is, the register values do not coincide with each other (NO in step S307). In this case, since “1” is written in the printer connection management register 206 (YES in step S308), the CPU 209 determines that the print service can be provided from the printer 101 to the DSC 102. Hence, based on a UPnP protocol, the communication adapter 100 transmits an “Alive” signal, representing that the printer 101 joins a logical network, to the DSC 102 via the wireless unit 205 (steps S309 and S405). The CPU 209 then writes, in the service status management register 207, “1” representing that the print service can be provided (step S310), and the flow returns to step S303.

Although not shown, upon reception of the “Alive” signal in step S405, the DSC 102 recognizes that the printer has joined the network. In order to use the print service, the DSC 102 issues a print instruction to the communication adapter 100. The DSC 102 uses the print service provided from the printer 101 via wireless communication (step S407) and USB communication (step S406).

In the above description, a case where the communication adapter 100 is connected to the printer 101 via the USB cable 104 is explained. A case wherein the connection via the USB cable 104 is disconnected will be described hereinafter.

Assume that the USB between the printer 101 and the communication adapter 100 is disconnected in step S408. The CPU 209 monitors the Vbus signal (not shown), and checks whether the Vbus signal changes (step S303). In this case, since the voltage level goes low, the CPU 209 determines that the USB is disconnected (NO in step S304). Upon disconnection of the USB, the USB communication between the communication adapter 100 and the printer 101 cannot be established. Accordingly, the CPU 209 writes “0” in the printer connection management register 206 (step S311). The CPU 209 then compares the content of the printer connection management register 206 with that of the service status management register 207 (step S307). The CPU 209 has written “0” in the printer connection management register 206 in step S311, and written “1” in the service status management register 207 in step S310. That is, the register values do not coincide with each other (NO in step S307). In this case, since “0” is written in the printer connection management register 206 (NO in step S308), the CPU 209 determines that the print service cannot be provided from the printer 101 to the DSC 102. Hence, based on the UPnP protocol, the communication adapter 100 transmits a “Bye-Bye” signal representing that the printer 101 leaves from the logical network, to the DSC 102 via the wireless unit 205 (steps S312 and S409). The CPU 209 then writes, in the service status management register 207, “0” representing that the print service cannot be provided (step S313).

In the first embodiment, the communication adapter which installs UPnP can detect the physical connection/disconnection with the printer to determine whether the printer can provide the print service. Based on whether the printer can provide the print service, the communication adapter determines that the printer joins the logical network and that the printer leaves from the logical network, thereby notifying the DSC of the determination result. Since the communication adapter notifies the DSC of the determination result after initializing the USB, the DSC can more accurately recognize the timing at which the print service becomes usable. Furthermore, since the communication adapter includes the printer connection management register 206 and the service status management register 207, the communication adapter can manage whether the printer is connected and whether the printer service is usable. When the contents of the two registers are changed, the communication adapter notifies the DSC that the printer joins the logical network or leaves from it. Hence, the communication adapter and the DSC can always recognize the same service status. Accordingly, the DSC can use the print service immediately after the printer is ready to provide the service. This decreases the risk of issuing the print instruction from the DSC to the printer incapable of providing the print service.

### Second Embodiment

In the second embodiment, a communication adapter 100 includes a wireless LAN connection management register in addition to a printer connection management register 206 and a service status management register 207.

A CPU 209 asynchronously controls a USB device controller 203 and a wireless unit 205. Hence, wireless LAN connection via the wireless unit 205 and USB connection with the printer 101 via the USB device controller 203 are independently established. Accordingly, even in a state wherein a DSC 102 is not within a communication range, or wherein the DSC 102 is not powered on, the communication adapter 100 may be connected to the printer 101 via the USB.

Even after establishing the wireless connection between the DSC 102 and the communication adapter 100, the wireless LAN may be disconnected when radio wave signals become weaker.

The wireless LAN connection management register is arranged in order to prevent, when the wireless LAN is disconnected, a software incorrect operation due to an “Alive” or “Bye-Bye” signal transmitted by the CPU 209.

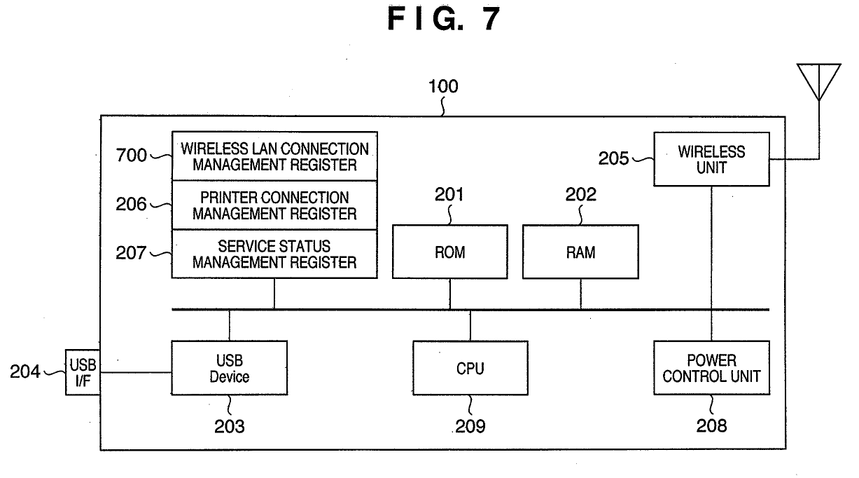

FIG. 7 is a schematic view of a communication adapter according to the second embodiment. A wireless LAN connection management register 700 manages information pertaining to whether the communication adapter 100 is connected to the DSC 102 via the wireless LAN. The remaining arrangement is the same as that in FIG. 2. The same reference numerals in FIG. 2 denote the same components as those in FIG. 7, and a description thereof will be omitted.

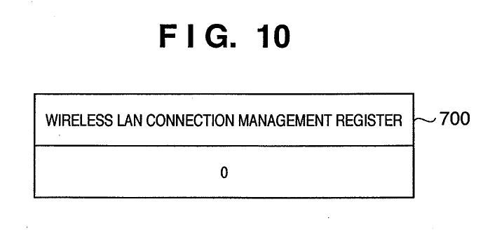

FIG. 10 is a view showing an example of a content of the wireless LAN connection management register 700. The CPU 209 writes “1” in the wireless LAN connection management register 700 in a case that the wireless LAN connection is completely established. Otherwise, the CPU 209 writes “0” in the wireless LAN connection management register 700.

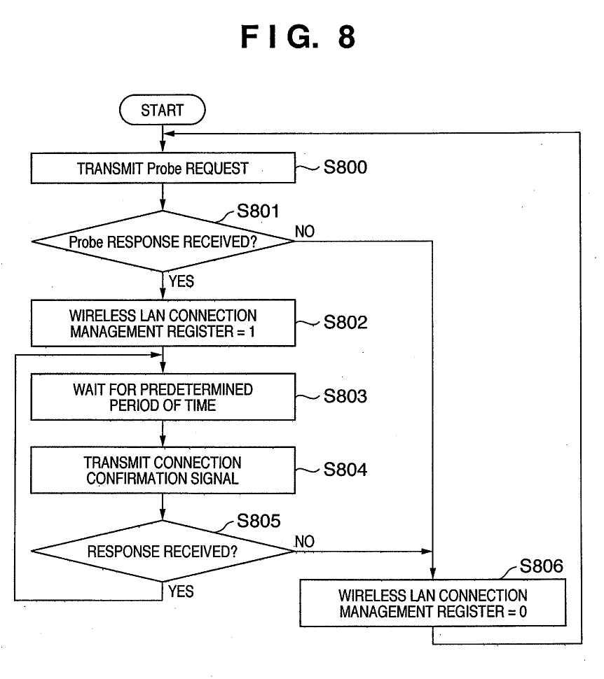

FIG. 8 is a flowchart showing processing pertaining to the control of a wireless unit performed by the CPU 209. First, the CPU 209 transmits a Probe Request signal (step S800), and checks whether a Probe Response signal is received in response to the Probe Request signal (step S801).

When the Probe Response signal cannot be received (NO in step S801), the CPU 209 writes “0” in the wireless LAN connection management register 700 (step S806). On the other hand, when the Probe Response signal can be received (YES in step S801), the CPU 209 determines that the wireless LAN connection is completely established, and writes “1” in the wireless LAN connection management register 700 (step S802). After an elapse of a predetermined period of time (step S803), the CPU 209 transmits a connection confirmation signal (step S804). If a response signal is received in response to this connection confirmation signal (YES in step S805), the flow returns to step S803. If no signal is received in response to the connection confirmation signal (NO in step S805), the CPU 209 writes “0” in the wireless LAN connection management register 700 (step S806), and the flow returns to step S800. As described above, even after the wireless LAN connection is established, the CPU 209 periodically confirms whether the wireless unit is connected with the wireless LAN, and updates the content of the wireless LAN management register 700. As the connection confirmation signal and the signal in response to it, a Probe Request signal and a Probe Response signal may be used.

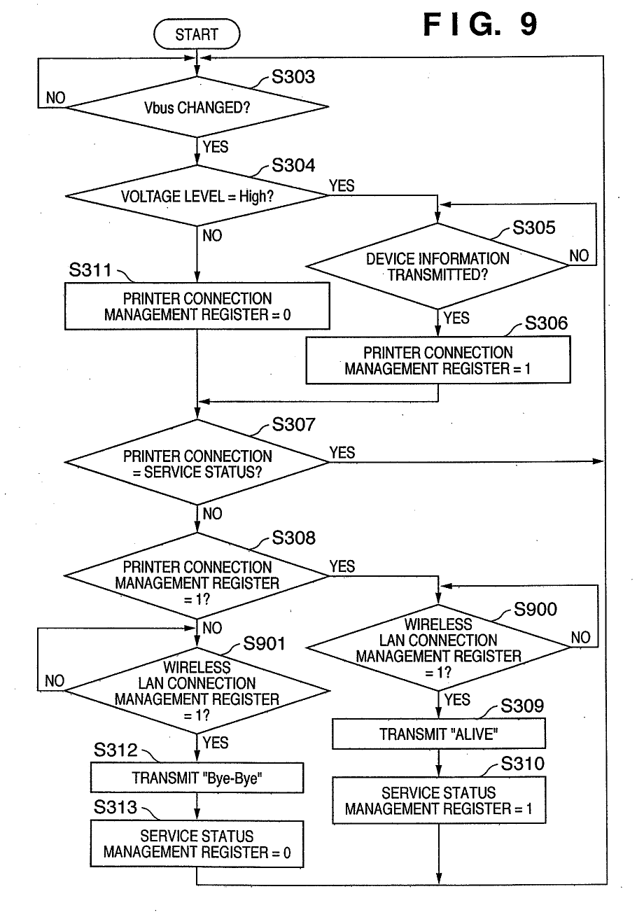

FIG. 9 is a flowchart showing processing pertaining to the control of the USB device controller 203 which is performed by the CPU 209. The processes in FIG. 9 are almost the same as those in FIG. 3 according to the first embodiment. In FIG. 9, steps S900 and S901 are added. Note that the same reference numerals in FIG. 9 denote the same steps as those in FIG. 3, and a description thereof will be omitted.

In the second embodiment, the CPU 209 in the communication adapter 100 transmits an “Alive” or “Bye-Bye” signal in a case that “1” is written in the wireless LAN connection management register 700, which is periodically updated in processing shown in FIG. 8. This operation is represented by “YES” in steps S900 and S901. Accordingly, the CPU 209 transmits the “Alive” or “Bye-Bye” signal only in a case that the communication adapter 100 is connected to the DSC 102 via the wireless LAN. If the communication adapter 100 is not connected to the DSC 102 via the wireless LAN, the CPU 209 transmits no signal and stands by until the wireless LAN connection is completely established.

According to the second embodiment, the CPU 209 transmits the “Alive” or “Bye-Bye” signal only in a case that the wireless LAN connection is established, thus reducing the possibility of software incorrect operations.

### Third Embodiment

In the first and second embodiments, the communication adapter 100 transmits the “Alive” or “Bye-Bye” signal when the communication adapter 100 is connected/disconnected to/from the printer 101 via the USB cable 104. However, in a case where an error such as a paper jam or ink shortage occurs, the printer 101 cannot print even if it is connected to the communication adapter 100. Therefore, in the third embodiment, a communication adapter 100 transmits an “Alive” or “Bye-Bye” signal in accordance with the error status of a printer in addition to the status of whether or not the printer is connected to the communication adapter.

In the third embodiment, upon detecting the connection between the communication adapter 100 and the printer 101 as in the first and second embodiments (YES in step S304 in FIGS. 3 and 9), one process is added to be performed. Upon detecting the connection with the communication adapter 100, the-printer 101 transmits its error status to the communication adapter 100. A CPU 209 confirms the error status transmitted from the printer 101. If no error occurs, then the CPU 209 writes “1” in a printer connection management register 206. If an error occurs, then the CPU 209 waits until an error recovery notification is received. Note that the printer 101 may transmit the error status together with a Get Descriptor (step S403 in FIG. 4). The communication adapter 100 may also make an inquiry about the error status together with the transmission of device information (step S305 in FIGS. 3 and 9, and step S404 in FIG. 4), and the printer 101 may transmit the error status in response to the inquiry. As described above, the communication adapter 100 transmits the “Alive” signal only in a case that no error occurs in the printer under the condition that the communication adapter 100 is connected to the printer 101. This further decreases the risk of issuing the print instruction from the DSC to the printer 101 incapable of providing the print service.

In each embodiment, the communication adapter 100 detects the USB connection/disconnection in step S303. In place of this operation, the communication adapter 100 may detect the power ON/OFF states of the printer 101 to obtain a similar effect.

In order to detect the connection/disconnection, the communication adapter 100 uses the voltage level of the Vbus signal. However, the communication adapter 100 may use a connection/disconnection command transmitted from the printer 101. By using the connection/disconnection command transmitted from the printer 101, the communication adapter 100 can transmit an “Alive” or “Bye-Bye” signal in accordance with the notification from the printer 101. In this case, the printer 101 may transmit a connection command to the communication adapter 100 in a case that no error occurs in the printer 101, and may not transmit the connection command in a case that an error occurs. Thus, the printer 101 can perform notification which is more suitable to the printer status.

Although the communication adapter 100 communicates with the DSC 102 via the wireless LAN in the above described embodiments, the adapter 100 may communicate with the DSC 102 via wired network.

Although the communication adapter 100 is connected with the printer 101 via USB in the embodiments, another wired connection such as Ethernet or IEEE1394 may be used to connect them.

Although the communication adapter 100 installs UPnP as a function of searching for a device and service, another function such as Rendezvous for searching for a device and service may be installed.

Although the communication adapter 100 transmits the “Alive” or “Bye-Bye” signal to the DSC 102, the communication adapter 100 may broadcast the signal (“broadcast” is to simultaneously transmit data to many unspecified devices). Alternatively, the communication adapter 100 may multicast the signal (“multicast” is to simultaneously transmit data to many specified devices). In broadcasting, many unspecified devices capable of communicating with the communication adapter 100 can recognize the presence of a device connected to the communication adapter 100, and a service provided by the device, thereby the adapter 100 can make use of the service. In multicasting, the communication adapter 100 can simultaneously transmit the “Alive” or “Bye-Bye” signal to many specified devices.

As signals to be transmitted from the communication adapter 100 to the DSC 102, the “Alive” and “Bye-Bye” signals are exemplified. However, the “Alive” signal may be a “print service start notification”, and the “Bye-Bye” signal may be a “print service end notification”. Also, the communication adapter 100 may transmit the “Alive” signal containing information for notifying of the start of the print service, and the “Bye-Bye” signal containing information for notifying of the end of the print service. In this case, a device which has received the notification can clearly recognize not only that the printer 101 joins the network or leaves from it, but also that the service starts or ends.

According to the above description, the communication adapter is to be connected to the printer. However, the present invention can be applied to a case wherein the communication adapter is to be connected to another device (such as a scanner or monitoring camera which provides a service to another device, and is capable of remote control, and a multi-functional peripheral with scanner and printer functions).

As described above, in the present invention, the communication apparatus is connected to an electronic apparatus which provides a predetermined service to be used by another apparatus. In this case, the present invention can prevent another apparatus from issuing a service request to the electronic apparatus incapable of providing a service.

The present invention is not limited to the above embodiments and various changes and modifications can be made within the spirit and scope of the present invention. Therefore, to apprise the public of the scope of the present invention, the following claims are made.

This application claims the benefit of Japanese Application No. 2005-177961, filed on Jun. 17, 2005, which is hereby incorporated by reference herein its entirety.

1-14. (canceled)

15. A communication apparatus comprising:
a first interface, adapted to communicate with a first electronic apparatus;
a second interface, adapted to communicate with a second electronic apparatus via a network;
a determination unit, adapted to determine a connection status with the first electronic apparatus via said first interface; and
a broadcast unit, adapted to broadcast, in accordance with the determination by said determination unit, a signal representing that the first electronic apparatus joins the network or leaves the network, to the network with which the communication apparatus communicates via said second interface.

16. The apparatus according to claim 15, wherein the connection status with the first electronic apparatus is determined based on a change in a voltage level of said first interface.

17. The apparatus according to claim 15, wherein said determination unit performs the determination based on a connection command or a disconnection command transmitted from the first electronic apparatus.

18. The apparatus according to claim 15, further comprising:
an identification unit, adapted to identify an error status of the first electronic apparatus;
wherein said determination unit performs the determination based on an error status identified by said identification unit.

19. The apparatus according to claim 15, wherein in a case that said determination unit determines that the first electronic apparatus is disconnected, said broadcast unit broadcasts a signal representing that the first electronic apparatus leaves the network.

20. The apparatus according to claim 15, wherein in a case that said determination unit determines that the first electronic apparatus is connected, said broadcast unit broadcasts a signal representing that the first electronic apparatus joins the network.

21. The apparatus according to claim 15, further comprising:
a request receiving unit, adapted to receive a device information transmission request from the first electronic apparatus; and
a sensing unit, adapted to sense, in accordance with the device information transmission request, that said first interface is completely initialized;
wherein said determination unit performs the determination based on a result sensed by said sensing unit.

22. The apparatus according to claim 15, further comprising:
a management unit, adapted to manage information containing connection information representing a connection status with the second electronic apparatus via said second interface,
wherein said broadcast unit does not broadcast the signal when the connection information represents that the second electronic apparatus is disconnected.

23. The apparatus according to claim 15, wherein
a signal representing that the first electronic apparatus joins the network broadcasted by said broadcast unit contains notification representing that the first electronic apparatus starts providing a service, and
a signal representing that the first electronic apparatus leaves the network broadcasted by said broadcast unit contains notification representing that the first electronic apparatus stops providing the service.

24. A communication apparatus comprising:
a first interface, adapted to communicate with a first electronic apparatus;
a second interface, adapted to communicate with a second electronic apparatus via a network;
a determination unit, adapted to determine a connection status with the first electronic apparatus via said first interface; and
a broadcast unit, adapted to broadcast, in accordance with the determination by said determination unit, a signal representing that the first electronic apparatus starts or stops providing a service, to the network via said second interface.

25. A communication method of a communication apparatus, comprising:
a determination step of determining a connection status with a first electronic apparatus, with which the communication apparatus communicates via a first interface; and
a broadcast step of broadcasting, in accordance with the determination in said determination step, a signal representing that the first electronic apparatus joins a network or leaves the network, to the network with which the communication apparatus communicates via a second interface.

26. A computer program for controlling a communication apparatus, comprising:
a determination step of determining a connection status with a first electronic apparatus, with which the communication apparatus communicates via a first interface; and
a broadcast step of broadcasting, in accordance with the determination in said determination step, a signal representing that the first electronic apparatus joins a network or leaves the network, to the network with which the communication apparatus communicates via a second interface.
